(19) United States
(12) Patent Application Publication
(10) Pub. No.: US 2022/0335553 A1
(43) Pub. Date: Oct. 20, 2022

(54) SYSTEM AND A METHOD FOR GENERATING AND MANAGING MACHINE EXECUTABLE DIGITAL CONTRACTS

(71) Applicant: QPQ Ltd., Dublin (IE)

(72) Inventors: Greg Chew, Dublin (IE); Emanuele Ragnoli, Dublin (IE)

(21) Appl. No.: 17/762,516

(22) PCT Filed: Nov. 17, 2020
(86) PCT No.: PCT/EP2020/082437

§ 371 Date: Mar. 22, 2022

(30) Foreign Application Priority Data
Nov. 18, 2019 (EP) 19209780.6

(51) Int. Cl. G06Q 50/18; G06F 16/14; G06F 16/16; G06Q 10/06; G06F 16/36; G06F 16/35; H04L 9/32

(52) U.S. Cl. CPC G06Q 50/182; G06F 16/144; G06F 16/164; G06Q 10/0635; G06F 16/367; G06Q 10/0639; G06F 16/35; H04L 9/3247; H04L 9/3236

(57) ABSTRACT

Systems and methods are used for generating and managing digital data files. More specifically, the system and method generate and manage digital contracts that execute the contractual terms of corresponding underlying legal contracts agreed between the parties. The system and method generate, for each digital contract, a corresponding master document data file representing the underlying physical legal contract document containing the contractual terms and conditions agreed between the parties.

### FIELD

The present invention relates to a system and a method for generating and managing machine executable digital data files. More specifically, the present invention relates to a system and a method for generating and managing machine executable digital contracts that comprise operative statements configured to control and/or monitor the operation of at least one contract input data source during the execution of the digital contract.

### BACKGROUND

Developments in the field of decentralised computer architectures and distributed ledger technologies (DLTs) have greatly increased the need for digital contracts which can be used to define and manage the terms of a contractual agreement for the provision of services/products between at least two contractual parties. Such a digital contract would provide the capacity to assess, regulate and govern the performance of the contract. Current ‘smart contracts’ fail to achieve this as they do not in themselves have the capacity to enforce and execute the intent of the parties in contract; they are simple digital protocols that can be used to automate a small set of specific functions but not to provide governance of the contract to which they are an externality. In order to enable digital governance contracts, the digital protocol must become interchangeable with the legal contract. Only then, the digital protocol can be used interchangeably with the legal contract to automate the assessment, regulation and governance of contractual performance by monitoring and/or managing the operation of devices and/or systems involved in the provision of the services/products/transactions/settlements specified in the legal contract. The contractual parties are in general legal entities e.g. an individual, company, or organization that have legal rights and obligation. Digital contracts may be used in a variety of scenarios. For example, a digital contract may be used to monitor and manage a supply chain transaction system, with inputs from sensor devices in an Internet of Things (IoT) network, the operation of autonomous vehicles, robotic devices operating in an industry 4.0 factory facility and the like.

An electronic representation of a physical contract such as one generated by saving a PDF version of an electronically signed contract is an e-contract rather than a digital contract. It has no operative effect other than to act as a digital representation of a physical legal contract that can be stored immutably in a blockchain. In general, a digital contract can be considered as a computer digital transaction protocol that executes the terms of the underlying legal contract agreed between the parties.

Digital contracts are considered to provide a highly effective measure for enforcing and verifying the performance of a contract between at least two parties. However, this is not always the case. Digital contracts are in general a representation of the contractual terms of a contract document into an executable digital contract machine code. As such, the digital contract machine code may include software bugs introduced during the development and/or compilation phase of the digital contract, which interfere and seriously impact the performance and functionality of the digital contract with disastrous effects. For example, a software bug may introduce a security vulnerability into the digital contract, which can be exploited by unwanted parties to manipulate the functionality of the digital contract. Such a security vulnerability was exploited on The DAO in 2016, causing the loss of an estimate US$50 million, while developers were trying to find a credible solution to fix the issue. In the case, where a digital contract is used to manage the operation of a system and/or a device e.g. an autonomous vehicle, or robotic systems, the consequences resulting from a software bug in the digital contract may be of greater magnitude.

### SUMMARY OF THE INVENTION

An object of the present invention is to provide a system and a method for generating digital contracts and corresponding underlying legal contracts containing the contractual terms and condition agreed between at least two parties.

The system and method of the present invention provides a solution for generating a digital contract and a corresponding underlying legal contract document, validating the executional performance of the digital contract before its execution by the intended application, and managing the executional performance of the digital contract during operation, and when necessary resolve dispute resolution issues arising between the contracting parties.

The object of the present invention is achieved according to the invention with the system and method showing the technical characteristics of the respective independent claims.

### BRIEF DESCRIPTION OF THE DRAWINGS

The following drawings are provided as an example to explain further and describe various aspects of the invention.

FIG. 1 shows an example of a digital contract platform according to embodiments of the present invention.

FIG. 2 shows an example of an architecture of the digital contract platform according to embodiments of the present invention.

FIG. 3 shows an example of a Source data file generation logic (SDFGL) according to embodiments of the present invention.

FIG. 4 shows an example of a knowledge database system according to embodiments of the present invention.

FIG. 5 shows an example of a graph database according to embodiments of the present invention.

FIG. 6 shows an example of a parser module according to embodiments of the present invention.

FIG. 7 shows an example of a Machine Contract Validation Logic (MCVL) according to embodiments of the present invention.

FIG. 8 shows an example of a Master data file generation logic (MDFGL) according to embodiments of the present invention.

FIG. 9 shows an example of a method for generating, validating and managing a digital contract according to embodiments of the present invention.

FIG. 10 shows an example of the method steps involved in generating a source digital data file.

FIG. 11 shows an example of the method steps involved in validating a machine contract programme.

FIG. 12 shows an example of the method steps involved in resolving a dispute between the parties according to embodiments of the present invention.

### DETAILED DESCRIPTION

According to a first aspect of the present invention, a system for generating a digital contract is provided that executes the contractual terms of a corresponding underlying physical legal contract agreed between at least two parties. For example, the system may be in the form of a digital contract computer platform configured to generate, validate, manage, and monitor executable machine contract programmes representing corresponding digital contracts, each configured to control and monitor the operation of one or more contract input data sources.

According to embodiments of the present disclosure, the digital contract platform may be provided with

a User Interface, UI, accessible by at least one user through a computer device; and

a digital contract generation logic configured to generate and manage at least one digital contract, based on input data received from the at least one user through the User Interface, UI.

According to embodiments of the present disclosure, the digital contract generation logic may be provided with a source data file generation logic, SDFGL, configured to generate, based on input data received from the at least one user through the User Interface, a source data file representing a first version of a physical legal contract comprising a set of operative statements, each comprising operative data comprising a set of contract conditions under which the parties agree to act during the term of the digital contract and a set of contract data inputs associated with at least one contract input data source.

According to embodiments of the present disclosure, the digital contract generation logic may be provided with a parser logic configured to analyse the source digital data file and at least extract the operative data from each operative statement, the parser logic comprising a machine contract generation logic, MCGL, configured to generate, based on the extracted operative data, a machine contract programme containing a set of software programme statements representing the extracted operative data, which machine contract programme is compiled to generate an executable machine contract programme representing the digital contract executing the operative statements contained in the source digital data file.

According to embodiments of the present disclosure, the digital contract generation logic may be provided with a machine contract validation logic, MCVL, configured to validate the enforceability and/or functionality of the generated machine contract programme by at least the parser logic may comprises a machine contract generation logic, MCGL, that is configured to generate, based on the extracted operative data, a machine contract programme containing a set of software programme statements representing the operative data extracted from the source data file. For example, the software statements may be in the form of IF CLAUSES, MAIN BODY, LOOPS, CALLS, and the like. file. The machine contract programme may be validated by means of machine contract validation logic, MCVL, which is configured to check the enforceability/applicability of the operative statements and the executional performance of the digital contract during operation. The MCVL generates a set of test conditions, also referred to as test cases or test scenarios, for the machine contract programme, which may involve varying the values of variables and/or vectors in the machine contract programme and recording the corresponding output values generated from each test condition. For example, the variable and/or vectors may be the contract inputs, libraries, classes, functions, object, and the like. The output values may be associated with corresponding operative statements. For example, the output values generated may be provided as input to the parser logic, or another software programme, whereby the output values are parsed to generate operating statements. The operative statements may be generated by associating each possible output value to a machine contract programme, based on the characteristics of the machine contract programme e.g. inputs, functions, classes, libraries, objects, calls, and the like. Each generated operative statement may be assigned a risk factor value. The risk factor value may indicate the applicability of each operative statement to the legal contract, based on the output values generated from the execution of each test case. The applicability of each operative statement may be linked to how enforceable each operative statement, and the contractual conditions contained therein, may be during execution. The enforceability data may be derived from historical data collected from each operative statement during execution or may be calculated based on a risk analysis statistical model using historical data provided by the user, and/or stored in a database e.g. a knowledge graph database. Furthermore, the risk factor may indicate whether the generated machine contract programme contains any vulnerabilities, which may affect adversely the execution of the digital contract during operation. For example, the machine contract programme may not respond as expected in one of the test cases applied by the MCVL, which may indicate a potential coding issue that needs to be fixed before the digital contract becomes operational. The MCVL is configured to generate, based on the value of the risk factor assigned to the operating statements generated from each test case, a validation signal indicating the successful validation of the machine contract programme, or an alert signal indicating a potential issue with machine contract programme code. For example, if the risk factor value is within a first performance threshold range, a validation signal may be generated, while if the risk factor value is within a second performance threshold range an alert signal may be generated. the validation signal may indicate that the machine contract programme is considered e.g. up to a certain degree, to represent the contractual conditions specified in the operative statements of the source digital data file and/or expected output values for each test case. An alert signal may indicate an issue with the applicability and/or enforceability of the operative statements. An alert signal may also indicate an issue with the execution of the digital contract. For example, if the risk factor has a specific value e.g. “0”, an alert signal may be raised indicating that the digital contract contains a serious issue that needs to be fixed before execution. In the case of an alert signal, the system of the present invention enables the at least one user to review and amend the affected portions of the source data file and/or the machine contract programme. For example, the at least one user may replace and/or amend defective operative statement. The updated source data file and/or machine contract code is re-validated using the parser and/or the MCVL. Once a validation signal is received, the source data file is converted into a master digital data file representing the underlying legal contract containing the contractual terms and conditions executed and/or monitored by the digital contract. The system of the present invention may be configured to communication with the users and/or parties via other communication means, such as email, online repositories, and the like. The at least one user and parties may review the master digital data file. Upon approval, the master digital datafile and the corresponding machine contract programme are stored in a versioned database e.g. Distributed Ledger Technology (DLT). In the case the at least one user and/or parties o not approve the master digital data file or want to make amendments, then the process starts at the appropriate step. The master digital data file may be a printable document, which has been generated based on a user selected contract template. The version database may be accessible by software applications linked to the digital contract and configured to execute the digital contract. The version database may be configured to record and store the data transmitted during the execution of the machine contract programme by the parties and their respective applications.

According to embodiments of the present invention, the source data file generation logic, SDFGL, comprising

a semantic search query generation logic, SSQGL, configured to generate, based on information extracted from the user input data, at least one search query comprising a plurality of search criteria;

a knowledge database system comprising an operative statement database containing a plurality of operative statements each tagged with a set of metadata information, and a semantic search engine configured to execute the at least one search query generated by the SSQGL so as to identify and retrieve from the operative statement database a set of operative statements associated with metadata information matching the search criteria of the at least one search query; and

a document generation logic configured to present to the user for selection, through the User Interface, the operative statements retrieved from the operative statement database, and, based on the user selection, to generate the source digital data file.

It has been found that the present invention allows for the at least one user to generate a source digital data file with relative ease. The SDFGL allows the at least one user to identify and select operative statements that are relevant for the intended application of the digital contract. The system of the present invention allows for operative statements to be retrieved from an operative database based on search queries generated from input data provided by the users. The operative database contains a plurality of operative statements each one tagged with metadata information comprising among other descriptive information about the operational statement. The search queries generated contain search criteria formatted according to the operative database that is used for storing the operational statements. The operative database may be communicatively coupled to a semantic search layer, which may be responsible for executing the search queries generated by the semantic search query generation logic, SSQGL. For example, the user may input through the user interface a set of descriptive keywords which are converted into a structured search query that may be used by the semantic search layer to retrieve information from the operative database. For example, the keywords may be a set of criteria relating to the intended use of the digital contract, the type of parties involved, the desired risk factor value for operative statement, and the like. The semantic search layer, based on the keywords, may search in the operative database system to identify operative statements that match at least some of the search criteria. The semantic search engine and the operative database may be part of knowledge database system. The operative statements retrieved from the operative database may be communicated to a document generation logic, which may be configured to display the search results to the at least one user for selection. The document generation logic may categorise and/or classify the search results containing the retrieved operative statements, according to user preferences, or other parameters e.g. relevancy. The operative statements selected by the user may be collected and used by the document generation logic to generate the source digital data file. The document generation logic may generate the source digital data file based on a template, which may be selected by the user. For example, the source document data file may be generated based on a physical contract document template. In the case that the user provides a digital document e.g. a contract as input data, the source data file generation logic, SDFGL may be configured to check the compatibility of the digital document e.g. language, structure, syntax compatibility, and accordingly is either use the user digital data file as source data file, or if an compatibility issues is detected, the convert the user digital data file content into a source digital data file.

According to embodiments of the present invention, the metadata information comprising a risk factor, and/or a classification, and/or an ontology associated with each operative statement. The metadata information may be collected from a plurality of sources e.g. during the execution of the operative statement. For example, the metadata information may indicate a risk factor for each operative statement, which may have been assigned with a call to the Risk Analysis Engine or with historical data collected during the execution of the operative statement by a related process e.g. by another programme. For example, the risk factor value may be assigned based on a) a statistical computation or tagged by a user or another process, b) queries to the graph database of the knowledge database system. The metadata information may further contain information relating to the ontology of each operative statement, which provides information on the properties of each operative statement and relationship and/or dependencies with other operative statements in the operative statement database. For example, the metadata information may indicate that the selection of an operative statement requires the integration in the digital contract of other dependent and/or related operative statements. Furthermore, the metadata information may include expected output values of each operative statement for different input value combinations, which may be used by the parser logic to identify the operative statements corresponding to each output value.

According to embodiments of the present invention, the operative statement database is a graph database. The use of a graph database enables the navigation and search through complex datasets with or without structured queries. Graph databases comprises a set of nodes and the relationships that connect them. In a graph database storing operative statements, each node may be configured to store at least one operative statement together its metadata information. Graphs represent entities as nodes and the ways in which those entities relate to the world as relationships. In this way, the use of graph databases enables to express complex relationships between node, or in our case operative statements, which enables the modelling of different scenarios. For example, the use of graph database for storing operative statements enables the modelling of different scenarios with regards to the enforceability of each operative statement during the execution of the digital contract e.g. the enforceability and performance of an operative statement during execution of the digital contract for different input data values. Querying relationships between operative statements within a graph database can be retrieved quickly, since the information is stored within the database itself. The relationships and/or dependencies between the operative statements can be visualised for easier navigation of heavy interconnected datasets. related is fast because they are perpetually stored within the database itself.

According to embodiments of the present invention, the least one search query is in a graph search query language. In order to access a graph database, the search query needs to be structured in specific format, which is closer to how the data is modelled in the graph database. A graph database query language may be used to prepare the search query e.g. the search query may be prepared in Cypher, SPARQL, or another graph database language.

According to embodiments of the present invention, the knowledge database system, comprises a knowledge graph logic configured to update and/or enrich the operative statements and associated metadata information stored in the operative database with information received and/or retrieved from a plurality of knowledge data sources. For example, the plurality of knowledge data sources may comprise external connected devices and systems, and/or the output values generated from the machine contract validation logic, and/or information received from the at least one user and/or the administrator of the system. The knowledge graph logic is configured to maintain the information stored in the operative statement graph database up to date. The knowledge graph logic is communicatively coupled to the different knowledge data sources, which includes external and/or internal data sources e.g. external devices and/or data generated from system modules. The knowledge graph logic may be configured to update the content of the graph database as soon as data becomes available and/or in batches e.g. from cached content. The knowledge database system may be configured to issue an update signal each time there is an update to the content of the graph database. For example, if there is an update on the content of the operative statements and/or the metadata information e.g. a change in the risk factor assigned to an operative statement, then an update signal may be issued indicating the presence of updated data in the graph database. In the case of digital contract, an update in the content of an operative statement e.g. a change in the risk factor, may necessitate a change in the digital contract or the revalidation of the digital contract. For example, after an update, an operative statement may be considered to be not applicable or unenforceable, thus necessitating a change in the source data file.

According to embodiments of the present invention, the knowledge graph logic comprising a set of trained algorithms configured to update and enrich the operative statements and associated metadata information. The knowledge graph logic may include an artificial intelligence algorithm that continuously updates the content of the operative database with data collected and/or retrieved from the plurality of sources.

Furthermore, the knowledge graph logic algorithms may learn from the use of the operative data in different digital contract scenarios, and accordingly may enrich the content of the graph database e.g. by creating new relationship links between statements, updating the risk factor value, updating the expected output values for each operative statement, and the like.

According to embodiments of the present invention, the machine contract programme and master digital datafile are hashed and stored in the versioning database. Preferably, the system of the present invention cryptographically signs and hash the generated digital data files and corresponding machine contract programme for each digital contract, which are subsequently stored in a versioned database. In this way, it becomes difficult to alter the content and/or functionality of a digital contract.

According to embodiments of the present invention, the MCVL is configured for validating the machine code program by:
reading the machine contract programme;
generating a set of test conditions for each operative statement;
executing the machine contract programme for each test condition;
storing the output values generated from each test condition;
generating, for each output value, the corresponding set of operative statements by submitting the output values to the parser logic, whereby each output value is processed and associated with a corresponding operative statement; and
assigning, by means of the risk analysis engine, a risk factor to each generated operative statement.

The system of the present invention enables the validation of the digital contract under different test conditions before its execution by the intended application. In this way, it becomes possibly to identify cases in which the digital contract may not perform as expected e.g. because of a software bug, or due to the enforceability of an operative statement. The MCVL executes the machine contract programme for a set of test conditions. For example, each test condition may involve applying different value combination to variable and/or vectors of the machine contract programme, which may include the contract input values, classes, libraries, functions, object, and the like. For each test condition, the system is configured to store the output values generated. The MVCL may map each output value to a corresponding operative statement. For example, the MCVL may be provided with a MCVL local database storing operative statements and expected outputs for different input value combinations. Furthermore, the MCVL may submit the output values generated to the parser logic, or another software programme, where they are processed and associated with an operative statement. For example, the parser logic may initiate queries to the operative database of the knowledge database system to identify operative statements corresponding to the output values generated. The MCVL may be provided with a risk analysis engine, which is configured to analyse the output values generated and accordingly assign a risk factor.

According to embodiments of the present invention, the risk analysis engine is configured to assign a risk factor to an operative statement, based on metadata information stored in the graph database. According to embodiments of the present invention, the risk analysis engine comprises a statistical risk calculation engine configured to calculate a risk factor based on historical information associated with an operative statement.

The risk analysis engine may assign the risk factor, based on information stored in the MCVL local database, and/or based on statistical models generated from historical information relating to the performance of specific operative statement. The historical information may be retrieved from external data sources e.g. external databases, or internal data sources e.g. MCVL local database and/or the graph database. For example, the historical information may be retrieved from the metadata information stored in the knowledge graph logic, and/or retrieved from external information sources such as external system databases.

According to embodiments of the present invention, the contract generation logic comprising a performance monitoring module communicatively coupled to contract input data sources associated with a machine contract programme, the performance monitoring module being configured for evaluating, based on input data received from connected contract input data sources, the performance of the machine contract program.

The performance monitoring module may allow the monitoring of the executional performance of a machine contract programme. The performance monitoring module may enable a user and/or a party to the contract to determine if the digital contract is executed as agreed. The performance monitoring module may be configured to receive data generated during the execution of the digital contract from the identified contract input data sources. For example, the performance monitoring module may be communicatively coupled e.g. via an Application Programming Interface (API), directly to the contract input data sources identified in the digital contract, and/or may be coupled to an information repository storing information collected from the contract input data sources during the execution of the digital contract. For example, the performance monitoring module may be configured to assess the performance of a Service Level Agreement (SLA) between a user and cloud provider based on information received from the cloud servers of the cloud provider on the use and reliability of the service agreed in the digital contract. Furthermore, the performance monitoring module may be configured to receive information directly from the digital contract parties regarding the executional performance of a digital contract. For example, a party may raise through the performance monitoring module a dispute issue relating to the incorrect execution of a digital contract or a part of the digital contract by the other party or parties.

According to embodiments of the present invention, the performance monitoring module is configured to periodically validate the performance of a machine contract programme stored in the version database by resubmitting it for validation to the machine code validation logic, MCVL. According to embodiments of the present invention, the step of resubmitting the machine contract programme to the machine code validation logic, MCVL, is triggered by an updated of the content of the operative statement database.

In this way, it is possible to evaluate the performance of the digital contract and associated operative statements over the validity period of the digital contract between the parties. An update in a company or government policy may render an operative statement unenforceable and/or invalid under certain conditions. For example, an update in the government policy with regarding the speed to be maintained by an autonomous vehicle on the road during heavy traffic, may render an operative statement invalid e.g. the operative statement does not provide a speed limit while the update government policy does provide a strict speed limit. Therefore, by resubmitting periodically each of the machine contract programmes stored in the versioned database to the MCVL, may enable the continuous assessment of the executional performance of the digital contract during the course of its validity period, and reduce the risk that the digital contract or parts of the digital contract become enforceable and/or invalid. The resubmission of a machine contract programme to the MCVL may be triggers by an update signal issued by the knowledge database system e.g. the knowledge graph, indicating an update in the content of the operative database. For example, the risk factor of some of the operative statements may be updated on a regular basis, which may impact the performance and/or validity of the digital contracts containing the updated operative statements e.g. because the risk factor of the operative statements would be below the performance threshold.

According to embodiments of the present invention, the performance monitoring module is configured, upon detecting an executional performance issue with a machine contract programme and/or receiving a dispute communication from at least one of the parties and/or at least one user, for issuing a dispute notification signal. According to embodiment of the present invention, the performance monitoring module comprises a dispute resolution engine configured, upon the issuance of a dispute notification signal, to activate a dispute resolution event sequence, and notify the parties involved and/or at least one user of the suspension of the disputed contract. According to embodiments of the present invention, the dispute resolution engine is configured to suggest dispute resolution proposals to the at least one user and/or parties for resolving the contract dispute, and wherein upon an acceptance by the parties and/or at least one user of a dispute resolution proposal, the dispute resolution engine being configured to regenerate a master digital data file and corresponding machine contract programme for the disputed contract. According to embodiments of the present invention the dispute resolution proposal comprise a set of operative statements retrieved from the knowledge database system.

The dispute resolution engine enables the quick and easy resolution of disputes arising between parties e.g. due to the incorrect execution of a digital contract term. The dispute resolution engine may assess the cause of the dispute resolution and accordingly suggest resolution proposals. For example, the dispute resolution engine may use the risk assessment engine to assess the risk in resolving a dispute. Furthermore, the dispute resolution engine may check the content of the operative database to determine if a similar dispute has been previously resolved. For example, the information relating to the dispute resolution arising by the execution of an operative statement may be part of the metadata information linked to each operative statement. Further, the dispute resolution may communicate the dispute to a dedicated dispute resolution centre that explicitly deals with disputes e.g. a dispute resolution panel. The dispute resolution engine based on the input of the dispute resolution centre or the dispute resolution information extracted from the operative database may proposed a set of resolution proposals to the parties e.g. amendments and/or actions to be taken.

According to embodiments of the present invention, the performance threshold is selected by the parties and/or the at least one user.

According to embodiments of the present invention, the operative statements indicate a set of instructions for controlling the operation of at least one contract input data source during execution of the digital contract. For example, the operative statements may comprise instructions that determine the operation of a remote device during the execution of the contract e.g. an autonomous vehicle, factory robots, digital devices, and the like. The system of the present invention may ensure that the device operation complies with the terms of the digital contract during its execution.

According to embodiments of the present invention, the at least one contract input data source is a device and/or a system configured for transmitting data collected from a predetermined environment. For example, the digital contract may be configured to monitor a range of sensors and/or devices in an Internet of Things network. The system of the present invention may be configured to monitor the operation of range of devices, and based on the information received, to assess the executional performance of the digital contract.

According to embodiments of the present invention, the at least one contract input data source is part an Internet of Things, IoT, infrastructure. According to embodiment of the present invention, the contract input data source comprises at least one IoT sensor.

According to embodiments of the present invention, the UI comprising a set of input and output data fields. For example, the User Interface (UI) may comprise a range of input fields to be used by the user to provide information to the system for the generation of a source digital data file. Furthermore, the UI may comprise a range of output fields, which may be used by the system to display information to the user e.g. the list of operative statements for selection, and/or a viewing window for the viewing the master digital data file. The UI may comprise a number of windows and graphical objects that may be used for the exchange of information between the user and the system of the present invention, and/or the user and other user sharing the same session.

According to embodiments of the present invention, the system may be configured to open for each user a unique user session, which may be shared with other users e.g. the parties to the digital contract. The sharing of the session may be performed through a unique identification number or token, which may be shared with other users to access details of the session, and/or perform operations e.g. providing information required for the generation of the digital contract, and/or sign and confirm the digital contract, and/or make or propose amendments.

According to embodiments of the present invention, the digital contract generation logic comprises a cryptographical module comprising a set of cryptological protocols for hashing, digitally signing and encrypting data stored in the versioned database. For example, the cryptological module may be in the form of a software library that includes software functions like hash, encrypt, sign, verify, etc, and may be appended/linked to the machine contract programme.

According to a second aspect of the present invention, a method is provided for generating digital contracts, each digital contract comprising a master digital data file and a corresponding machine contract programme, each contract being configured to govern a transactional relationship between at least two parties, the method comprising:

generating, validating, and managing, by means of a digital contract generation logic, at least one digital contract from input data received from at least one user and by:

exchanging data, through a User Interface, UI, with at least one user the UI being accessible through at least one computer device;

receiving input data, by means of a source data file generation logic, SDFGL from the at least one user through the User Interface, the SDFGL being configured to propose, based on the user input data, a set of operative statements to the user for selection, the SDFGL being configured to generate, based on the user-selected operative statements, a source digital data file, wherein each operative statement comprising operative data comprising a set of instructions controlling the operation of the digital contract and a set of contract data inputs, each contract data input being associated with at least one data source;

analysing, by means of a parser logic, the source digital data file and least extracting the operative data from each operative statement, the parser logic comprising a machine contract generation logic, MCGL, configured to convert the extracted operative data, a set of software programme statements, and generate, based on the set of software programme statements and contract data inputs defined in the operative data, a machine contract programme written in a source language corresponding to the source digital data file, the MCGL is configured, based on the type of the logical operations executed in the software programme statements and associated contract data inputs and data sources, to append to the machine contract programme a set of calls to software libraries and/or classes for the execution of the machine contract programme;
validating, by means of a machine contract programme validation logic, MCVL, the executional performance and/or functionality of the generated machine contract programme, the MCVL being configured to execute the generated machine contract programme by applying different input value combinations to the contract data inputs and recording the output values generated for each input value combination, the MCVL comprising a risk analysis engine configured to assign a risk factor to each of the generated output values, the risk factor being indicative of the executional performance and/or functionality of the machine contract programme for a specific input value combination,

wherein, when the assigned risk factor of each output value is equal or above a performance threshold, the MCVL is configured to issue a validation signal indicating a successful validation of the executional performance of the generated machine contract programme, and

wherein, when the assigned risk factor of at least one output value is below the performance threshold, the MCVL is configured to issue an alert signal to the user indicating a potential issue with the executional performance of the machine contract program, which needs to be resolved;

generating, by means of a master data file generation logic, MDFGL, upon receiving a validation signal, a master digital data file from the source data file, the master digital data file and/or the machine contract programme being transmitted, through the User Interface and/or a preferred communication medium, to the at least one user and/or directly to the parties identified in the source data file for an agreement confirmation and signature, the MDFGL being configured, upon receiving the agreement confirmation and signature, to store the master digital data file and the corresponding machine contract programme to a versioned database.

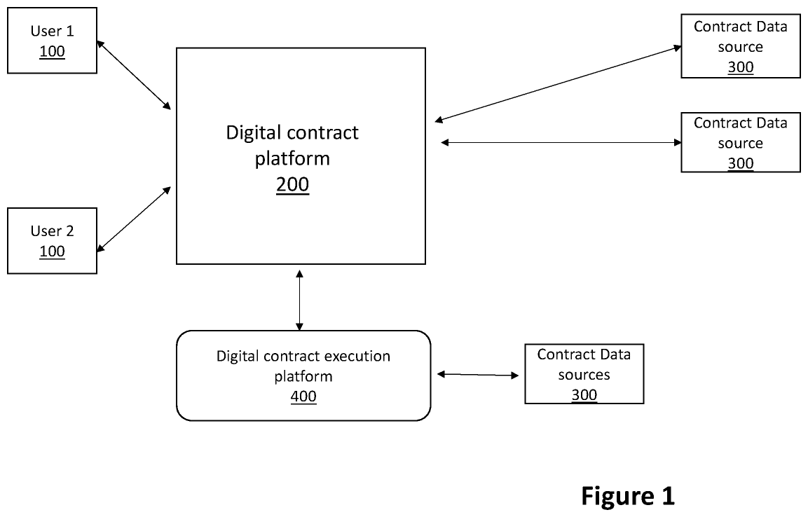

The present invention will be illustrated using the exemplified embodiments shown in the FIGS. 1 to 12, which will be described in more detail below. It should be noted that any references made to dimensions are only indicative and do not restrict the invention in any way. While this invention has been shown and described with reference to certain illustrated embodiments thereof, it will be understood by those skilled in the art that various changes in form and details may be made therein without departing from the scope of the invention encompassed by the appended claims. Furthermore, while the invention has been described with references to a particular system and/or a method for generating, validating and managing digital contracts, it should be understood by those skilled in the art that changes in form and details may be made to facilitate other types of method and/or systems in related fields without departing from the scope of the invention encompassed by the appended claims.

FIG. 1 shows an example of digital contract platform 200 configured to generate, validate and manage digital contracts according to embodiments of the present invention. The digital contract platform 200 may operate as a cloud-based service, which is accessible to users 100 via a communication network e.g. through a web server. Each user 100 may access the digital contract platform through a user computing device e.g. a phone, tablet, computer and the like, to generate, validate and manage digital contracts. For example, a party to a digital contract may access the digital contract platform to determine whether the digital contract is being executed according to the terms and conditions agreed. The digital contract platform 200 may configured to obtain contract performance information relating to the execution of the digital contract from the contract input data sources 300. The contract data sources 300 may be devices and/or systems involved in the execution of the digital contract, which may be configured to transmit data during their operation. For example, the contract data sources 300 may be sensors deployed in an Internet of Things (IoT) infrastructure, and/or system configured for recording transactions between the parties e.g. financial transactions, and/or interconnected systems configured to gather information from secondary devices e.g. a central repository that stores information for connected devices. Furthermore, the digital contract platform 200 may be communicatively coupled to a digital contract execution platform 400 that is configured for executing the digital contract. The digital contract execution platform 400 may be communicatively coupled to a connected contract data source 300. For example, the digital contract execution platform 400 may provide information on the execution of the digital contract to the digital contract platform 200. According to embodiments of the present invention, the digital contract platform 400 may be part of the digital contract platform 200.

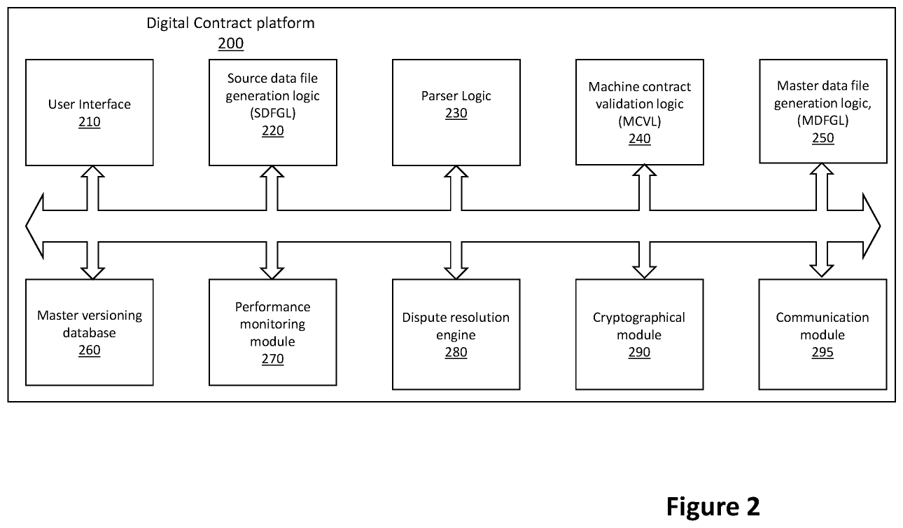

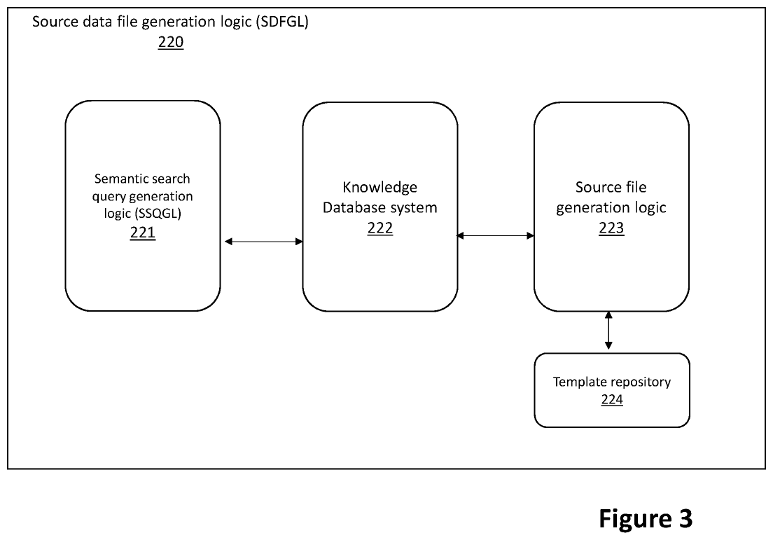

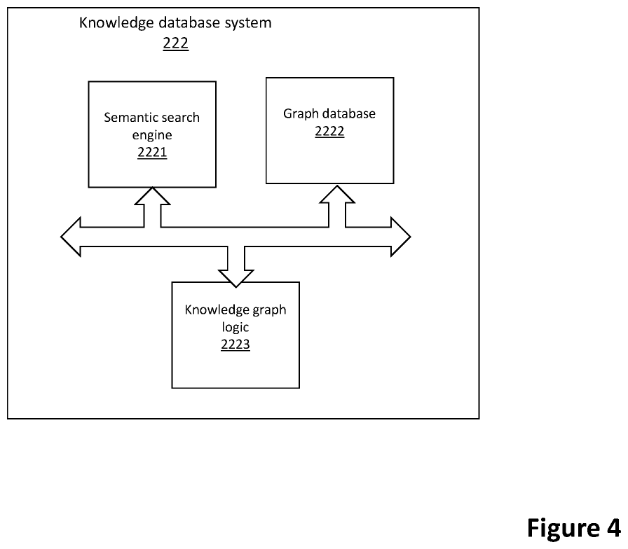

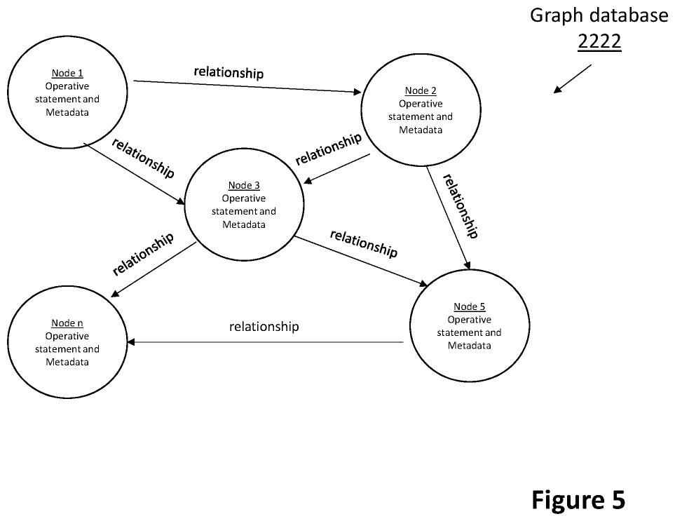

FIGS. 2 to 8 show examples of the digital contract platform architecture according to embodiments of the present invention. As shown in FIG. 1, the digital contract platform may be provided with a plurality of modules each configured to perform a specific functionality. As previously mentioned, the digital contract platform 200 may be hosted on a cloud service provider. The digital contract platform 200 may be provided with a User Interface (UI) 210, which accessible by a user through a computer device. For example, the UI 210 may be in the form of a web page, or in the form of a software application installed in the user computer device. Through the UI 210 the user may interact with the digital contract platform 200 for the generation, validation and managing of a digital contract. The UI 210 comprises a plurality of input and output data fields that are used by the user to interact with the digital contract platform. For example, the user may insert keywords, in the input data fields, which may be used by the digital contract platform 200 to identify relevant operative statements for the generation of a digital contract, which are displayed on designated output data fields of the UI 210 for selection by the user. The keywords may be in the form of criteria for retrieving operative statements e.g. intended use of the contract, business sector, type of operations performed during the execution of the digital contract. The digital contract platform 200 comprises a Source Data File Generation Logic (SDFGL) 220, which is configured to receive the input data from the at least one user through the User Interface (UI) 210. The SDFGL 220 is configured to propose, based on the user input data, a set of operative statements to the user for selection, which may be displayed on the user computer device through the UI 210. The SDFGL 220 being configured to generate, based on the user-selected operative statements, a source digital data file. The source digital data file containing a set of operative statements that may have been selected by the user, based on a set of user-defined criteria. Each of the operative statements may comprise operative data comprising a set of contract conditions under which the parties agree to act during the term of the digital contract instructions controlling the operation of the digital contract during execution and a set of contract data inputs, each contract data input being associated with at least one contract data source 300. The operative data may further comprise information relating to the operative statement such as sector, type of transactions involved in the digital contract, type of assets or services involved, type of principals, medium of exchange, and the like. The at least one contract data source 300 may be in the form of an entity e.g. a device, a person, a system, and the like, configured to perform certain functions during the execution of the digital contract. The operation of each contract data source 300 may be monitored to determine the executional performance of the digital contract. The generation of the source digital data file may be based on a user-selected template e.g. a legal contract template. As shown in FIG. 3, the Source data file generation logic (SDFGL) 220 may be provided with a semantic search query generation logic (SSQGL) 221 configured to convert the input data provided by the user into a semantic search query comprising a plurality of search criteria for retrieving operative statements from a knowledge database system 222. For example, the search criteria may relate to the business sector, type of parties involved, entities monitored e.g. devices, system, type of digital contract, and the like. The operative statements retrieved from the knowledge database system 222 may be forwarded the at least one user for selection e.g. through the UI 210. A source file generation logic 223 may be provided to generate from the selected operative statements a source digital data file. The source file generation logic 223 may prepare the source digital data file based on a template retrieved, based on a user selection, from a template repository 224. For example, the source digital data file may be intended to be used as a Service Level Agreement (SLA) between a service provider and customer, which would require the monitoring of the entities and/or assets involved in the provision of the service e.g. an SLA between a cloud service provider and a customer would require the monitoring of the server devices to determine compliance of service with the terms and provisions provided in the SLA. As shown in FIG. 4, the knowledge database system 222 may be provided with a semantic search engine 2221 configured to execute the semantic search query generated by the SSQGL 221 to retrieve operative statements from a graph database 2222. For example, the graph database 2222 may be a NoSQL database configured to accept search queries written in a graph database search query language e.g. cypher, SPARQL, and the like. As shown in FIG. 5, the graph database 2222 may be configured to store information as entities (nodes) and relationship (edges) and enables a user to query the data as a graph. For example, each node of the graph database may be configured to store at least one operative statement. In addition, each node in the graph database may store metadata information associated with the corresponding operative statement. The metadata information may comprise a plurality of information relating to the corresponding operative statement e.g. risk factor, classification, ontology, dependencies with other operative statements, historical information, and the like. The metadata information may be collected from a plurality of data sources e.g. device operation during the execution of the digital contract, output values from the Machine Contract Validation Logic (MCVL) 240, and the like. For example, the metadata information may indicate a risk factor for each operative statement, which may have been assigned based on historical data collected during the execution of the operative statement by a related process e.g. by another programme. The metadata information may further contain information relating to the ontology of each operative statement, which provides information on the properties of each operative statement and relationship and/or dependencies with other operative statements in the operative statement database. For example, the metadata information may indicate that the selection of an operative statement requires the integration in the digital contract of other dependent and/or related operative statements. The semantic search query generation logic (SSQGL) 221 may be configured to generate a semantic search query in a desired graph database search query language. Moreover, the semantic search engine 2221 may be configured to format the semantic search query into a graph database language. The knowledge database system 222 may be provided with a knowledge graph logic 2223 configured to update and/or enrich the operative statements and associated metadata information stored in the operative database with information received and/or retrieved from a plurality of knowledge data sources. For example, the plurality of knowledge data sources may comprise external connected devices and systems, and/or the output values generated from the machine contract validation logic, and/or information received from the at least one user and/or the administrator of the system. The knowledge graph logic 2223 may be configured to maintain the information stored in the operative statement graph database up to date. The knowledge graph logic is communicatively coupled to the different knowledge data sources, which includes external and/or internal data sources e.g. external devices and/or data generated from system modules. The knowledge graph logic 2223 may be configured to update the content of the graph database as soon as data becomes available and/or in batches e.g. from cached content. The knowledge database system 222 may be configured to issue an update signal each time there is an update to the content of the graph database. For example, if there is an update on the content of the operative statements and/or the metadata information e.g. a change in the risk factor assigned to an operative statement, then an update signal may be issued indicating the presence of updated data in the graph database. In the case of digital contract, an update in the content of an operative statement e.g. a change in the risk factor, may necessitate a change in the digital contract or the revalidation of the digital contract. For example, after an update the risk factor of an operative statement may fall below the performance threshold, which may necessitate the issuance of an alert signal to the user and/or a change in the digital contract. The knowledge graph logic 2223 may be provided with a set of trained algorithms configured to update and enrich the operative statements and associated metadata information. The knowledge graph logic 2223 may include an artificial intelligence algorithm that continuously updates the content of the operative database with data collected and/or retrieved from the plurality of sources. Furthermore, the knowledge graph logic algorithms may learn from the use of the operative data in different digital contract scenarios, and accordingly may enrich the content of the graph database e.g. by creating new relationship links between statements.

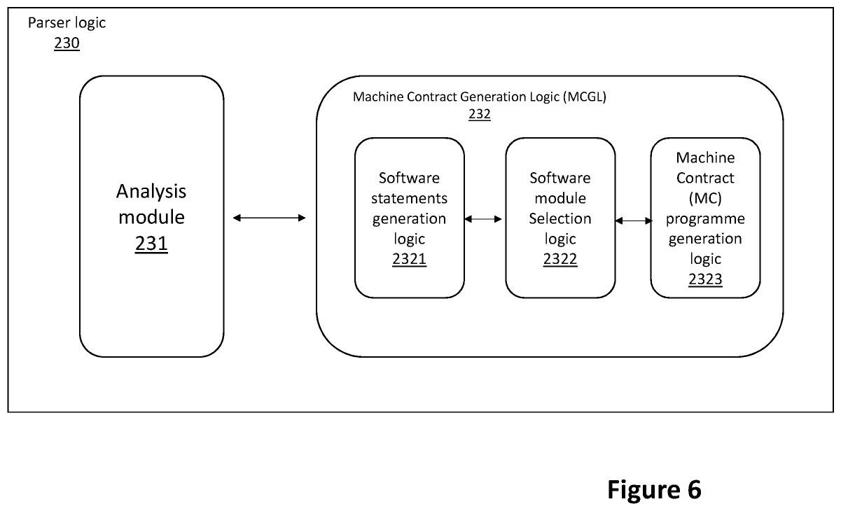

Once the source digital data file has been created, a parser logic 230 is used to analyse the source digital data file. The parser logic may be a computer software program that parses the source digital data file to extract operative data from each operative statement. The parser logic 230 may extract from the source digital data file a range of information e.g. the structure and format of the file, the logical operations involved in the operative statements, the contract data inputs, expected outcomes, and the like. As shown in FIG. 6, the parser logic 230 may comprise an analysis module 231 configured to analyse the source digital data file to extract a set of operative data e.g. structure, format, contract data inputs, contract data sources, logical operations performed in the operative statements, type of operations to be performed, and the like. The extracted operative data is then communicated to a Machine Contract Generation Logic (MCGL) 232, which is configured to generate, based on the extracted operative data, a machine contract programme, which when executed performs the operations specified in the operative statements of the digital source data file. The MCGL 232 may comprise a software statement generation logic 2321 configured to generate, based on the extracted operative data, a machine contract programme.

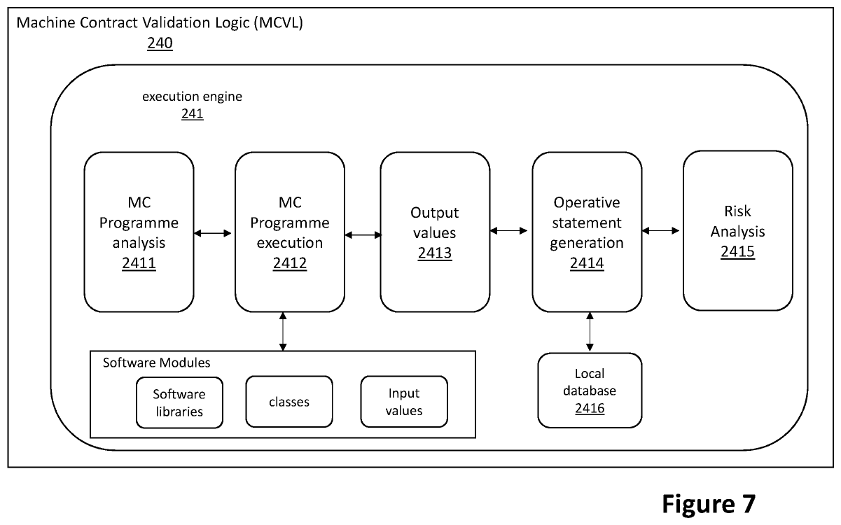

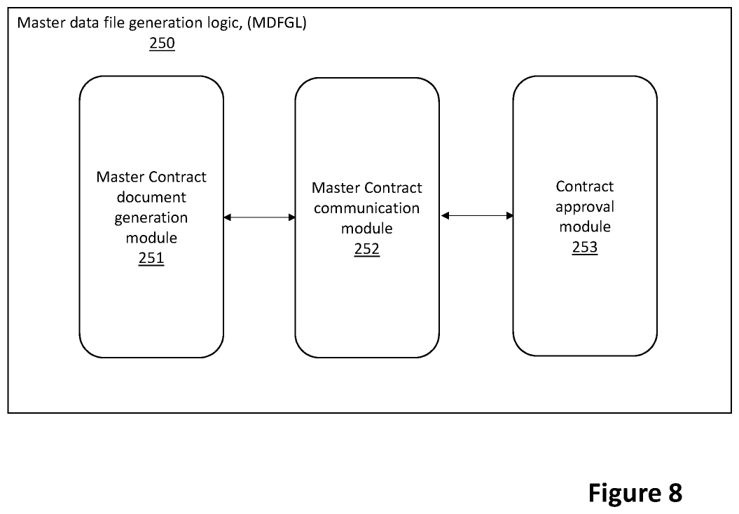

comprising a set of software programme statements. For example, the software logic may use the operative data as keywords to search to a linked database for applicable software statements, and accordingly generate a machine contract programme containing software statements that call the specific sector of the linked library. For example, the MGCL takes the operative data as inputs and with text analytics searches Machine Contracts libraries, then associate the operative data to the relevant sectors of the Machine contract libraries and generates a machine contract programme containing software programme statements that call the specific sectors of the linked libraries and associated commands. For example, the software statement generation logic 2321 may generate an if-else conditional statement to represent the conditional statement logical operations involved in an operative statement of the source data file. The MCGL 232 may comprise a software module selection logic 2322 which is configured to select a set of software modules e.g. software libraries, classes, Application Programming Interface (API) calls to 3d party interfaces, and the like, to be linked to the generated software statements. The software modules may be selected based on the type of operations involved in the software programme statements and associated contract data inputs and data sources. The MCGL 232 may comprise a MC programme generation logic 2323 configured to generate a machine contract programme comprising the generated software statements and links to the selected software modules, which are called during the execution of the digital contract. The machine contract programme is written in a desired programming language. Although not shown in FIG. 6, the parser logic 230 may comprise a compiler configured to compile the generated machine contract programme into an executable machine contract code. For example, the compiler may process the software statements of the machine contract programme and convert them into machine language or “code” that a computer processor can execute. The machine contract code may represent the digital contract to be executed by a desired application. It should be noted that the compiler may not necessarily be part of the digital contract platform 200. For example, the machine contract programme may be compiled at the software application being configured to execute the digital contract. The digital contract platform 200 is configured to validate the executional performance of the generated machine contract programme by means of a machine contract validation logic (MCVL) 240. An example of the architecture of the MCVL 240 is shown in FIG. 7. The MCVL 240 may comprise an execution engine 241 which is configured to execute the machine contract programme for all at least all possible contract data input combination values to determine the executional performance of the digital contract under different operating scenarios/conditions. The execution engine 241 may comprise a Machine Contract (MC) programme analysis module 2411, which is configured to analyse the Machine contract programme to create the different operating scenarios. For example, the MC programme analysis logic 2411 may be configured to generate a set of operating scenarios for the digital contract under different input conditions e.g. by applying different input value combinations to the contract data inputs. The Machine contract programme may then be executed for each operating scenario by means of a Machine contract (MC) programme execution module 2412. The MC programme execution module 2412 may execute the machine contract programme under the conditions specified in each operating scenario. For example, the MC programme execution module 2412 may execute the machine contract programme by calling the linked software modules in the machine contract programme, reading the contract data inputs and outputs, applying different input value combinations to the contract data inputs as specified by each operating scenario, and executing the machine contract programme for each input value combination. The output values generated by each input value combination during the execution of the machine contract programme under an operating scenario may be captured and stored in an output value module 2413. The output values may be used by the combinatorial engine to identify the corresponding operating statements. For example, the combinatorial engine 241 may comprise an operating statement generation module 2414 configured to generate for each output value the corresponding operating statement. The operating statements may be retrieved from a local repository 2416 e.g. a local repository storing operating statements and corresponding output values in the form of a Look-Up-Table (LUT) in a local repository module. Furthermore, the corresponding operating statements may be retrieved, by means of the parser logic or another software programme, from a knowledge database system 222. The generated operating statements may then be processed by a risk analysis engine 2415, which is configured to assign a risk factor value to each operating statement. The risk factor may be indicative of the applicability and/or enforceability of an operative statement. Furthermore, the risk factor value may be indicative of a potential issues with the execution of the digital contract, e.g. if the risk factor is of certain value e.g. R=0 The risk factor may be applied using a statistical risk calculation engine configured to statistically apply a risk factor value to an operative statement based on set of condition such as historical information, and the like. For example, the risk analysis engine may be configured to assign a risk factor value to an operative statement, based on metadata information stored in the knowledge database system 222, and/or in another database. The risk analysis engine 2415 may assign the risk factor, based on information stored in an MCVL local database, and/or based on statistical models generated from historical information relating to the performance of specific operative statement. The historical information may be retrieved from external data sources e.g. external databases, or internal data sources e.g. MCVL local database and/or the graph database 2222. For example, the historical information may be retrieved from the metadata information stored in the knowledge database system 222, and/or retrieved from external information sources such as external system databases. The execution engine 241 may be configured for assessing whether the risk factor assigned to each of the generated statements falls within a contract performance threshold, which may be selected by the user. For example, the execution engine 241 may be configured when the risk factor assigned to each generated operative statement is within the specified contract performance threshold e.g. equal or above the contract performance threshold, to issue a validation signal indicating that the machine contract programme has been validated for the different operating scenarios. The combinatorial engine 241 may be configured to issue an alert signal if at least one of the generated operative statement is assigned a risk factor that is below the specified contract performance threshold. The alert signal may be transmitted to the user and may indicate that there is an issue with the executional performance of at least some of the operating statements selected to generate the source digital data file. The user may decide to amend the operating statements and the process of validation would be performed again. The user may decide to continue to the next stage despite the alert raised by the combinatorial engine. The digital contract platform 200 may comprise a Master data file generation logic (MDFGL) 250, which is configured to generate, upon the issuance of a validation signal from the combinatorial engine 241 and/or at the command of the user, a master digital data file from the source digital data file. As shown in FIG. 8, the MDFGL 250 may comprise a master contract document generation logic 251, which is configured to convert the source digital data file into a master digital data file. The master digital data file may be in the form of a legally enforceable legal contract representing the terms and condition implemented in the digital contract. The master digital data file is in electronic form and may be printed by the user. The master digital datafile may be generated based on a desired template, which may have been selected by the user. The MDFGL 250 may comprise a master contract communication module 252, which may be configured to communicate the master digital data file and/or the machine contract programme for review to the at least one user and/or parties identified in the input data provided by the at least one user. The communication module 252 may communicate with the at least one user and/or parties through the UI 210 and/or through another desired communication medium e.g. email, webserver, and the like. The at least one user and/or parties may confirm their agreement to the proposed digital contract by digitally signing the master digital data file and/or machine contract code. A contract approval module 253 may be provided for handling the signing of the digital contract. Once signed the master digital data file and corresponding machine contract programme is hashed by means of a cryptographical module 290. The cryptographical module 290 may comprise a set of cryptological protocols for hashing, digitally signing and encrypting data stored in the versioned database. For example, the cryptological module may be in the form of a software library that includes software functions like hash, encrypt, sign, verify, etc, and may be appended/linked to the machine contract programme. The hashed master digital data file and corresponding machine contract programme code may be stored in a master versioning database 260. The versioning database 260 may be configured to store changes to the digital contract made by the at least one user and/or parties, and/or other information associated with the generation, validation, and management of a digital contract. As previously mentioned, the digital contract platform 200 may be provided with a compiler logic, configured to compile a machine contract programme into machine contact code, which can be executed by a desired software application. Alternatively, the machine contract programme may be compiled by the software application executing the digital contract.

The digital contract platform 200 may be provided with a performance monitoring module 270 configured to monitor the execution of a digital contract by monitoring the operation of the corresponding contract input data sources. The performance monitoring module 270 may be communicatively coupled to the contract input data sources associated with a machine contract programme. The performance monitoring module 270 may be configured for evaluating, based on input data received from connected contract input data sources, the performance of the machine contract program. As a result, with use of a performance monitoring module 270 it may be possible for a user to manage the execution of a digital contract. For example, the performance monitoring module may be communicatively coupled e.g. via an Application Programming Interface (API), directly to the contract input data sources identified in the digital contract, and/or may be coupled to an information repository storing information collected from the contract input data sources during the execution of the digital contract. The performance monitoring module 270 may be configured to periodically submit the machine contract programmes stored in the versioning database for revalidation to the MCVL 240. In this way, it may be possible to revaluate the executional performance of a digital contract over the validity period of the contract and account for updates in the operative statements metadata information. For example, an update in a company or government policy may render an operative statement unenforceable and/or invalid under certain conditions. Furthermore, the performance monitoring module 270 may be configured to receive information directly from the digital contract parties regarding the executional performance of a digital contract. For example, a party may raise through the performance monitoring module 270 a dispute issue relating to the incorrect execution of a digital contract or a part of the digital contract by the other party or parties. the performance monitoring module 270 may be configured upon detecting an executional performance issue with a machine contract programme and/or receiving a dispute communication from at least one of the parties and/or at least one user, for issuing a dispute notification signal. A dispute resolution engine 280 may be provided for handling the dispute resolution. For example, the dispute resolution engine 280 may be configured, upon the issuance of a dispute notification signal, to activate a dispute resolution event sequence, and notify the parties involved and/or at least one user of the suspension of the disputed contract. The digital contract platform may be provided with a communication module 295, which may be used for the exchange of data between the digital contract platform and external modules e.g. the contract input data sources.

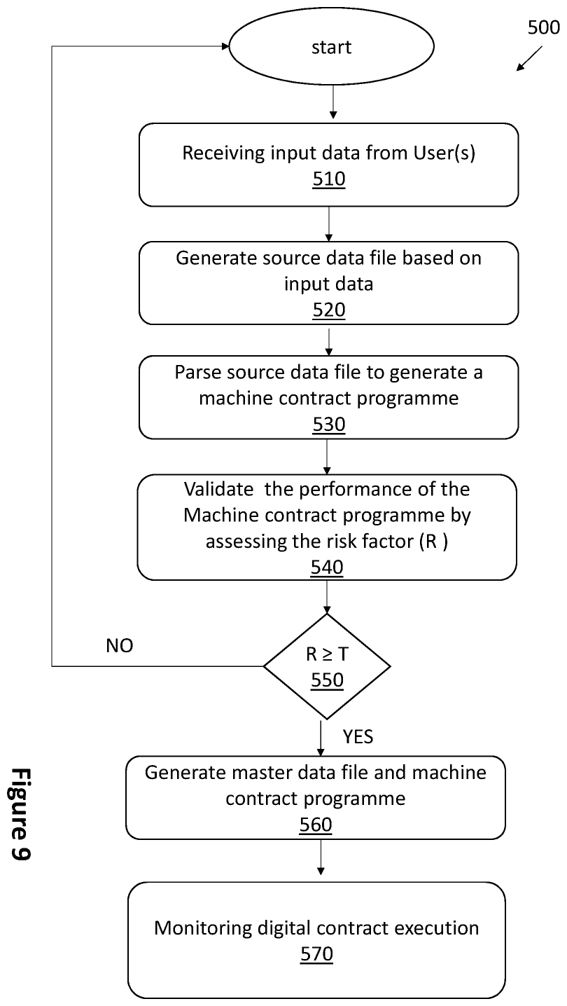

FIG. 9 shows an exemplified computer implemented method 500 for generating and managing digital contracts according to embodiments of the present invention. The method 500 starts with at least one user accessing the digital contract platform 200 though a user computer device running the UI 210. The at least one user, at step 510, is provided with a unique user session and is requested to provide input data into a set of input data fields, which may be used as keywords for the retrieval of operative statements from an operative database. For example, the input data fields may be in the form of search engine requesting the user to provide a set of keywords or criteria. Furthermore, the at least one user may further provide information relating to the parties involved, the nature of the digital contract, and the like. Based on the input data provided by the user, a set of operative statements are displayed to the user for selection. The user may select relevant operative statements, and/or may decide to re-run the search using a new and/or modified set of keywords. Once the user is satisfied with the operative statement selection, the method moves to step 520, whereby a source digital data file is generated from the selected operative statements. The source digital data file may be in the form of a legal contract, and/or in another format. At step 530 the source data file is parsed to extract operative data comprising at least the structure, logical operations, and contract data inputs. The extracted operative data is then converted into a machine contract programme written in a desired programming language. The machine contract programme represents in programming code the functionality of the operative statements of the source digital data file. At step 540 the executional performance of the machine contract programme is validated. At step 540 the machine contract programme is executed under different conditions and the outputs generated each time are associated with an operative statement. Each operative statement is assessed to determine its risk factor (R) value, which may be indicative of the applicability and/or enforceability of operative statements in the machine contract programme. At step 550, the risk factor (R) of each operating statement may be compared to a user defined contract performance Threshold (T). If the risk factor (R) of the operative statements generated during validation is within a first performance threshold range, e.g. equal or greater than the user defined contract performance threshold (T) value, a validation signal is generated and the method proceeds to step 560, otherwise the user is notified that there is an issue with the machine contract programme, which needs to be resolved. For example, if the risk factor is equal to a predetermined value e.g. R=0 then an alert signal may be issue indicate a potential vulnerability of the machine programme code. The operative statements and associated risk factor generated in steps 540 and 550 may be summited as input to the knowledge database system 222, where they may be used by the Knowledge 2223 to update the content of the graph database 2222. At step 560, the corresponding source digital data file of the validated machined contract programme is converted into a master digital data file and is transmitted for signature and confirmation to the at least one user and/or parties identified in the contract. The validated machine contract programme may also be transmitted together with the master digital data file. Once the master digital data file and/or machine contract programme are signed, then they are hashed and placed on a versioning database ready to be used for execution by a desired application. Once a machine contract programme is executed by a desired application, its performance is monitored at step 570, e.g. by assessing the information received from the contract input data sources during the execution of the contract. The information received may be stored in the versioning database 260. Furthermore, the at least one user and/or parties may use the monitoring information to manage the operation of a digital contract.

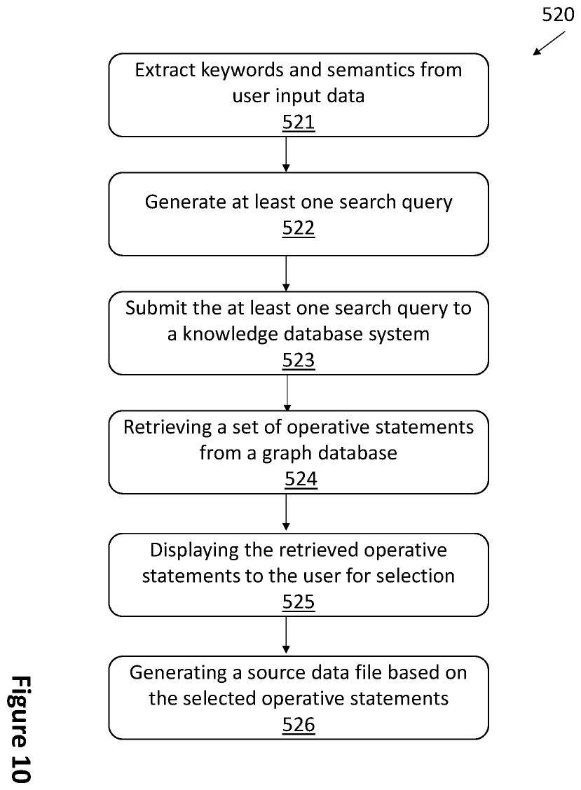

FIG. 10 shows an example of the method steps involved in the generation of the source digital data file 520. At step 521, based on the user input data, a set of keywords and search criteria are extracted for the retrieval of operative statements from an operative database. At step 522, based on the search of keywords and input data set of search queries are generated, which are submitted in step 523 to a knowledge database system for the retrieval of operative statements. At step 524, the statements are retrieved from a graph database and are displayed, at step 525, to the user computer device, through the UI 210, for selection. At step 526, the operative statements together with other information provided by the user e.g. parties, devices involved, etc. are converted into a source digital data file, which may be presented in a predetermined format.

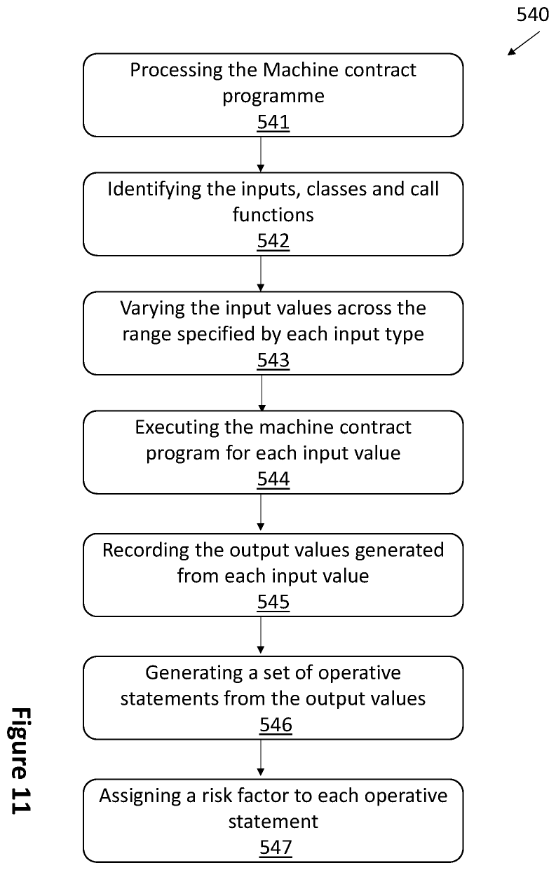

FIG. 11 shows an example of the steps involved in the validation of the machine contract programme at step 540. The generated machine contract programme is processed, at step 541, to identify the characteristics of the programme e.g. contract data inputs, types of logical operations, and the like. At step 542, the relevant inputs, classes, and call functions to software libraries are identified. At step 543, different operating condition scenarios are generated based on different input value combinations. At step 544, the machine contract programme is executed under the operating conditions stated in each scenario, and the resulting output values of the machine contract programme form each operating condition scenario are recording at step 545. At step 546, the output values generated from each operating condition scenario are associated with an operative statement, and a risk factor is assigned to each operative statement at step 547. The risk factor may be statistically derived from historical data or may be retrieved from the graph database.

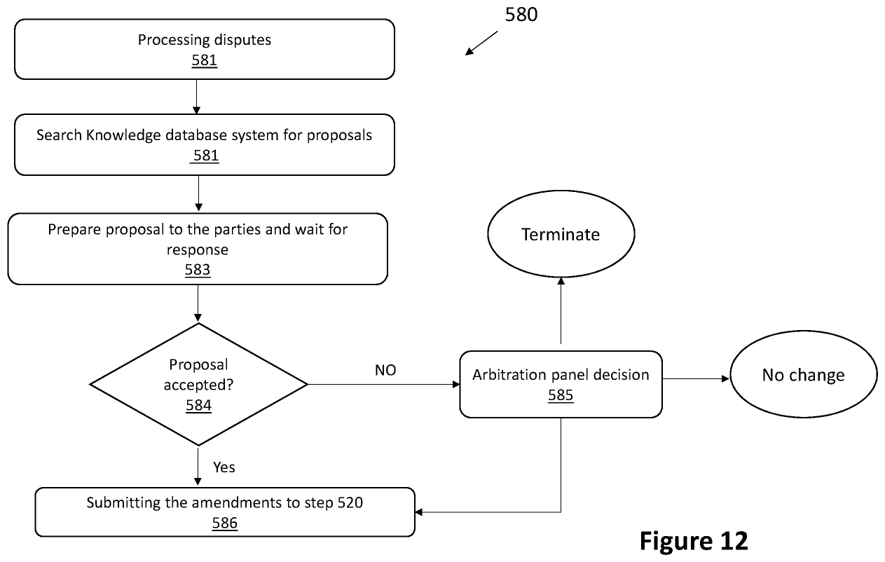

FIG. 12 shows an example of the steps involved in resolving a dispute between the parties 580. Once a dispute is raised by one of the parties or identified by the monitoring module, it is processed at step 581 to determine the nature of the dispute. At step 582, the graph database may be accessed to retrieve proposals for resolving the dispute resolution, which have been used in similar cases. At step 583, the proposals are submitted to the parties involved in the dispute for confirmation. if the proposal put forward to the parties is accepted at step 584, then the proposed amendments to the digital contract are submitted to step 520 of the method of FIG. 9, for the generation of an amended source digital data file. If the parties at step 584 reject the proposal, then the dispute resolution is transferred to step 585, whereby an arbitration panel e.g. a panel of experts, would take a decision on the dispute resolution. Depending on the decision, several outcomes may be possible. For example, if the arbitration panel requires amendments to the digital contact, then the request is transfer to step 586 for the generation of an amended source digital data file. However, the arbitration panel may deice to terminate the digital contact or to maintain the digital contract as generated. A set of examples are presented to illustrate how the present invention may be used by contractual parties to generate and digital contracts that executes the terms and conditions of an underlying physical legal contract. It should be noted that although the examples start with an existing draft contract between the parties, which is submitted to the source data file generation logic (SDFGL), the parties may equally use the present invention, as has been previously mentioned to generate a source data file, representing a draft contract.

### Example 1: Sale of Goods Between Two Parties

Alice contracts to sell to Bob goods that conform to the following characteristics: goods will be delivered by a certain date; goods will satisfy certain quality metrics; goods will satisfy certain quantity metrics; the price of the goods will depend on the goods satisfying the conditions above.

1) Alice and Bob write a Draft Contract, that is submitted as input data to the digital contract platform 200 via the User Interface 210 where it may be digitalised, digitally saved and stored on the master versioning database 260, e.g. a DLT.
2) The Draft Contract is digitally signed and stored on the DLT that can be accessed by both Alice and Bob.
3) The Draft Contract is submitted to the SDFGL 220, where it is used to generate a Source Data File (SDF) by means of a parser, which extracts from the draft contract operative data like sector (supply chain/logistic), principals (Alice and Bob), type of transaction (sale), inputs (price of the goods, goods quantities, good qualities). The parser 230 may further extract the contractual terms and conditions specified in the draft contract.
4) The SDF is submitted to the MCGL 232 that parses the SDF, extracts operative data (i.e. supply chain, Principals, type of assets, operative statements etc) and converts the operative data to software statements that write calls the appropriate libraries (supply chain trading programmes), the appropriate functions (sale), appropriate variables and objects for goods. Operative statements such as contractual terms and conditions existing in the SDF are converted to software IF CLAUSES. The output is the Machine contract, that is submitted to a version-controlled repository.
5) Alice and Bob agree on a risk threshold and on a set of Operative Statements, that are submitted to the Knowledge Database System 222.
6) The Machine Contract is either compiled or interpreted into Machine Code and is submitted to the MCVL 240, which validates the machine contract programme by running the code with all the possible inputs and calls to all the possible functions, classes and libraries. The outputs and related inputs are sent to the Risk Analysis Engine that runs a set of risk algorithms and labels the outputs with their related risk factor. Then the outputs and related inputs are sent to the SDFGL that, with a parser or text analytics algorithms, embeds the outputs to text sentences like “If beetles are found in the packing case then the goods will be rejected regardless of whether there is any damage to the goods”, that becomes and Operative Statement and with its related risk factor is submitted to the Knowledge Database System.
7) If any of the outputs has a critical risk factor like zero then a major software bug/vulnerability has been detected and a request of change is flagged. The machine contract is changed and resubmitted.
8) The Draft Contract is submitted to a text analytics engine, which outputs Knowledge Database Systems queries that generates Operative Statements with related risk factors. For example, the query would be, what are the Operative Statements and related Risk Factors that covers cases in supply chain, with certain goods, on these markets?
9) Now there are 3 sets of Operative Statements with risk factors. The ones as output of the MCVL, the ones agreed by Alice and Bob, the ones as output of the queries of the text analytics engine. All of those that have a risk factor higher than the decided threshold are appended to the SDF, the output is a Legal Contract, that is digitally signed by Alice and Bob, hashed and submitted to a DLT that can be accessed by both Alice and Bob.

If a dispute is generated between Alice and Bob, a Trade Dispute is flagged and written as an Operative Statement. That is an input to the text analytics engine and its outputs, together with any type of type of sensors reading (like IOT) and the output become Knowledge Database System queries, that generates Operative Statements with related risk factor. Alice and Bob are asked to review and if they agree to append the new Operative Statements to the Legal Contract. If they disagree a panel of experts is asked to review. Depending on the decision a Legal Contract is digitally signed, hashed and submitted to a DLT that can be accessed by all the Principals or a subset of them. The New Operative Statements are also submitted to the SDFGL, the MCGL and the MCVL and a new Machine Contract is generated.

### Example 2: Logistics Contract for the Delivery of Goods in Example 1

Alice contracts to sell to Bob goods that utilise third party logistics services from Charlie. Charlie would contract with Alice to deliver the goods to Bob. To do so, he would collect the goods from Alice when instructed, compliantly transport (for example, maintaining temperature) and deliver those goods to Bob. Once the goods are ready for collection from Alice, a networked device, such as computer device running a software programme, would prompt Charlie to dispatch a truck to collect the goods, indicating the temperature at which the goods must be transported, and how the goods should be handled and any special notices about the goods such as whether or not they contain any hazardous materials. Upon delivery of the goods to Bob's premises as directed by the digital contract, a computer device would log the delivery e.g. a computer device running a software programme, and generate a signal confirming the delivery on a networked device, which would be communicated to the application executing the digital contract to indicate that some or all of the terms and conditions relating to the delivery of goods from Alice to Bob have been performed and that all of the conditions for payment of Charlie by Alice have been performed, enabling the digital contract between Alice and Bob and the digital contract between Alice and Charlie to operate accordingly. In general, the system of the present invention may be used by the contractual parties to generate the digital contract governing their contractual relationship, as followed:

1) Alice and Charlie write a Draft Contract, that is digitalized, digitally saved and stored on a DLT.
2) The Draft Contract is digitally signed and stored on a DLT that can be accessed by both Alice and Charlie.
3) The Draft Contract is submitted to the SDFGL, a parser extracts operative data like sector (supply chain/logistic), principals (Alice and Charlie), type of transaction (service), inputs (weight of goods, dimensions of goods, distances between where the goods are collected and where they are deposited), the relevant operative elements of the contract between Alice and Bob and outputs a SDF, such as the relevant contractual clauses.
4) The SDF is submitted to the MCGL that converts the operative data to software statements that write calls the appropriate libraries (supply chain logistics programmes), the appropriate functions (service), appropriate variables and objects for logistics. Operative statements existing in the SDF are converted to software statements e.g. IF CLAUSES. The output is a Machine contract programme, that is submitted to a version-controlled repository.
5) Alice and Charlie agree on a risk threshold and on a set of Operative Statements, that are submitted to the Knowledge Database System.
6) The Machine Contract is compiled or interpreted into Machine contract Code and is submitted to the MCVL, that runs the code with all the possible inputs and calls to all the possible functions, classes and libraries. The outputs are sent to the Risk Analysis Engine that runs a set of risk algorithms and labels the outputs with their related risk factor. Then the outputs are sent to the SDFGL that converts the outputs in Operative Statements that are submitted to the Knowledge Database System that updates its graph database.
7) If any of the outputs have a critical risk factor like zero then a major software bug/vulnerability has been detected and a request of change is flagged. The machine contract is changed and resubmitted.
8) The Draft Contract is submitted to a text analytics engine and it outputs Knowledge Database Systems queries that generates Operative Statements with related risk factors.
9) Now there are 3 sets of Operative Statements with risk factors. The ones as output of the MCVL, the ones agreed by Alice and Charlie along with those that have operative effect in the digital contract between Alice and Bob and the ones as output of the queries of the text analytics engine. All of those that have a risk factor higher than the decided threshold are appended to the Draft Contract, the output is a Legal Contract, that is digitally signed by Alice and Charlie, hashed and submitted to a DLT that can be accessed by both Alice and Charlie.

If a dispute is generated between Alice and Charlie, a Trade Dispute is flagged and written as an Operative Statement. That is input to the text analytics engine and its outputs, together with any type of type of sensors reading (like IOT) and the output become Knowledge Database System queries, that generates Operative Statements with related risk factor. Alice and Charlie are asked to review and if they agree to append the new Operative Statements to the Legal Contract. If they disagree a panel of experts is asked to review. Depending on the decision a Legal Contract is digitally signed, hashed and submitted to a DLT that can be accessed by all the Principals or a subset of them. The New Operative Statements are also submitted to the SDFGL, the MCGL and the MCVL and a new machine contract is generated.

### Example 3: Regulation of Self-Driving Vehicles as Used by Charlie to Perform his Tasks in Example 2

The legislator creates a set of laws governing the use of self-driving vehicles in private and commercial contexts. A regulator is created whose role is to ensure compliance with these rules by private and commercial operators of self-driving vehicles. That regulator wishes to ensure that compliance is built into the operation of these vehicles, so the operating code of the self-driving vehicle is made subject to the governance of the regulator and a digital contract is created between the regulator and the regulated operating software of the self-driving vehicle).

There would only be one party to the digital contract that can change the terms and they may do so unilaterally with decisions informed to the regulated counterparties. The Regulator would therefore

1) Have the legislation (draft contract) digitalised, digitally saved and stored on a DLT.
2) The Draft Contract is digitally signed and stored on a DLT that can be accessed by any relevant party (such as Charlie) but only edited and amended by the Regulator.
3) The Draft Contract is submitted to the SDFGL, the parser extracts operative data like sector (rules of the road, vehicular transportation), principals (regulator and regulated), type of transaction (governing regulation), inputs (speed limits, usage limits, compliance with signage, load limits, etc.), the relevant operative elements of the legislation and outputs an SDF.
4) The SDF is submitted to the MCGL that converts the operative data to software statements that write calls the appropriate libraries (rules of the road, logistics, transport, vehicular use), the appropriate functions (regulation), appropriate variables and objects for the use of self-driving vehicles. Operative statements existing in the SDF are converted to software IF CLAUSES. The output is the Machine contract, that is submitted to a version-controlled repository.
5) The Regulator sets a risk threshold and on a set of Operative Statements, that are submitted to the Knowledge Database System.
6) The Machine Contract is compiled or interpreted into Machine Code and is submitted to the MCVL, that runs the code with all the possible inputs and calls to all the possible functions, classes and libraries. The outputs are sent to the Risk Analysis Engine that runs a set of risk algorithms and labels the outputs with their related risk factor. Then the outputs are sent to the SDFGL that converts the outputs in Operative Statements that are submitted to the Knowledge Database System that updates its graph database.
7) If any of the outputs have a critical risk factor like zero then a major software bug/vulnerability has been detected and a request of change is flagged. The machine contract is changed and resubmitted.
8) The Draft Contract is submitted to a text analytics engine and it outputs Knowledge Database Systems queries that generates Operative Statements with related risk factors.
9) Now there are 3 sets of Operative Statements with risk factors. The ones as output of the MCVL, the ones set by the Regulator and the ones as output of the queries of the text analytics engine. All of those that have a risk factor higher than the decided threshold are appended to the Legislation (Draft Contract), the output is a Legal Contract of Regulation, that is digitally signed by the Regulator and all of the Regulated, hashed and submitted to a DLT that can be accessed by both Regulated and Regulator.

If a dispute or query is generated by a Regulated entity seeking clarification of rules, a Dispute is flagged and written as an Operative Statement. That is input to the text analytics engine and its outputs, together with any type of type of statistical data supporting the proposition and the output become Knowledge Database System queries, that generates Operative Statements with related risk factor. The Regulator is asked to review and if they agree to append the new Operative Statements to the Legal Contract. If they disagree a panel of experts is asked to review. Depending on the decision a Legal Contract is digitally signed, hashed and submitted to a DLT that can be accessed by all the Regulator and the Regulated. The New Operative Statements are also submitted to the SDFGL, the MCGL and the MCVL and a new machine contract is generated.

This in turn creates operative code that would be required to be inserted into any digital contract by commercial operators such as Charlie in example 2.

Charlie therefore has to insert certain operative clauses into any contract he has, such as that self-driving vehicles cannot be used in certain weather conditions and therefore Charlie cannot collect, transport or deliver in such conditions.

Further, Charlie cannot undertake a contract with Alice that would require that Charlie's self-driving vehicle exceeds the speed limit on the routes that would be used in the performance of the contract between them as the operative code of the Regulator cannot be disregarded.

The Regulations thus have an overriding effect on the contracts that it impacts and compliance with the regulations can be said to be both automated and complete.

### Example 4: Controlling and Monitoring the Operation of an Autonomous Vehicle

Autonomous vehicles would need to be continuously controlled and monitored to ensure that they operate according to a set of criteria and guidelines on how to operate in specific situations. It is expected, depending on the use of the autonomous vehicles, that different categories of autonomous vehicle would exist. Each category would be required to abide by a set of specific criteria. For example, certain vehicle may be used for transportation e.g. buses, trucks, taxis, and the like, while others may be used for personal use. It is expected that autonomous vehicles would include Artificial Intelligence algorithms e.g. machine learning algorithms, that would help them continuously learn and adapt to their surroundings. Therefore, the behaviour and operation of the autonomous vehicles would change over time. As such it is essential that the operation of the autonomous vehicle is controlled and continuously monitored.

In order to control and monitor the operation of each autonomous vehicle, and/or autonomous vehicles in a specific category, each autonomous vehicle may be provided with access to a machine executable digital contract. The machine executable contract may comprise a set of operative statements that have been defined to control and monitor the operation of the autonomous vehicle.

To create the machine executable digital contract, a user may access the digital contract platform of the present disclosure. Through the user interface (UI), the user may provide input data, such as search keywords, to identify operative statements that are applicable to the specific use of the autonomous vehicle.

The keywords provided by the user may be used by the source data file generation logic, SDFGL, which is provided with a semantic search query generation logic, SSQGL, configured to generate, based on information extracted from the user input data, at least one search query comprising a plurality of search criteria.

The search query is submitted to a knowledge database system comprising an operative statement database containing a plurality of operative statements each tagged with a set of metadata information, and a semantic search engine configured to execute the at least one search query generated by the SSQGL so as to identify and retrieve from the operative statement database a set of operative statements associated with metadata information matching the search criteria of the at least one search query. The retrieved operative statements are configured to control and/or monitor the operation of the autonomous vehicles/vehicles, which are specified as contract input data sources during the execution of the digital contract. For example, the operative statements retrieved may relate to applicable laws for operating the autonomous vehicles on the road e.g. highway code or relates, the measures that the autonomous vehicles should follows when encountering pedestrians, what to do in certain situations e.g. when an accident happens, how to respond a call from the user of the autonomous vehicle e.g. emergency call, and the like.

A document generation logic is provided to present to the user for selection, through the User Interface, the operative statements retrieved from the operative statement database. Based on the user selection, the document generation logic is configured to generate a source digital data file. For example, the source digital data file may be a human-readable medium or in a human-readable format comprising encoded data or information that can be naturally read by humans. In computing, human-readable data is often encoded as ASCII or Unicode text. Similarly, the source digital data file may be in computer machine readable format.

The source data file may represent a first version of a physical legal contract comprising a set of operative statements, each comprising operative data comprising a set of conditions and criteria that are to be followed by the autonomous vehicle during the term of the digital contract.

The source data file is then parsed using the parser logic to extract operative data from the operative statements in the source digital data file. The parser logic is configured to generate, based on the extracted operative data, a machine contract programme, which when executed performs the operations specified in the operative statements contained in the source digital data file.

As previously stated, machine contract programmes are vulnerable to errors, which may only be detectable during operation of the machine contract programme, or only when a condition becomes true. These errors are extremely hard to point out and usually are only discovered when the machine contract programme is operational. The usual approach, when an error is discovered is to develop a patch, which is then uploaded in the machine contract programme to fix the errors. These errors may be exploited by a hackers to take control over the machine contract programme, which in the case of autonomous vehicles would be catastrophic and would endanger the lives of people.

Therefore, in order to validate the machine contract programme developed by the digital contract platform a machine contract validation logic, MCVL, may be provided. The MCVL comprises an execution engine which is configured to execute the machine contract programme for different contract data input combination values to determine the executional performance of the digital contract under different operating scenarios and/or conditions. the MCVL is configured to assign a risk factor to each operative statement, which is compared to a predetermined performance threshold e.g. a threshold assigned by the user. I the risk factor is within a first threshold range from the performance threshold e.g. at or above the predetermined threshold, then a validation signal is generated. Otherwise the MCVL generates an alert signal, indicating a vulnerability in the machine contract programme, which is reported to the user. Upon receiving a validation signal the machine contract programme is transmitted to the at least one user to be signed, and upon signature the machine contract programme is hashed and placed on a versioning database ready to be used for execution by the autonomous vehicle.

Once the autonomous vehicle starts to execute the machine contract programme, it transmits to a performance monitoring module a set of operational data. The performance monitoring module is configured to monitor the execution of the digital contract by monitoring the operation data received by the autonomous vehicle and accordingly evaluate whether the autonomous vehicle operates according to the operative statements of the digital contract.

In this way, the continuous monitoring and control of the operation of the autonomous vehicle is ensured. Furthermore, in the case that certain operative statements in the digital contract need to be changed, e.g. because of a legislative change it the traffic code, or a user requirement, then a new digital contract may be generated and put into operation.

The digital contract may be submitted for revalidation at specified intervals to ensure that its executable performance is within a certain level, and free from vulnerabilities.

### Example 6: An Automatic Laser Engraving Tool Needs to Perform According to a Set of Instructions Received by a User

Engraving images with laser cutting is a notorious hard problem when performed on metal surfaces characterised by irregularities and different surface curvatures. The movement and intensity of the laser are governed by software, the machine code, that receives as inputs the scan and characteristics of the image to be engraved, via image processing. The quality of the final product is highly dependent on the combination of the image resolution, the metal surface characteristics and the laser precision.

A customer contracts with an engraver that owns an autonomous manufacturing machine (an autonomous laser engraving machine) to obtain the engraving of a set of images with different resolution and characteristics on metal surfaces with different irregular curvatures and characteristics with the acceptance of the final product subject to fuzzy quality objectives. The contract regulates the decision and method of the machine to engrave the images on metal surfaces or not and therefore impacts the consequent acceptance of the engraver production of an engraved image. The contract translates in a Machine Contract that, when run on the machine, instructs the machine how to operate on different combinations of images and metal sheets.

1) the customer and the engraver write a Draft Contract, that is submitted as input data to the digital contract platform 200 via the User Interface 210 where it may be digitalised, digitally saved and stored on the master versioning database 260, e.g. a DLT.
2) the Draft Contract is digitally signed and stored on the DLT that can be accessed by any authorised user.
3) the Draft Contract is submitted to the SDFGL 220, where it is used to generate a Source Data File (SDF) by means of a parser, which extracts from the draft contract operative data like sector (image processing/metal surfaces, curvatures/image resolution), users (metal engravers), type of transaction (engrave or not), inputs (image files and image characteristics). The parser 230 may further extract the contractual terms and conditions specified in the draft contract.
4) The SDF is submitted to the MCGL 232 that parses the SDF, extracts operative data (material, surfaces curvatures, images, image definition, quality attributes, engraving activity) and converts the operative data to software statements that write calls the appropriate libraries (engraving software programmes), the appropriate functions (engrave), appropriate variables and objects for images and metal sheet surfaces. Operative statements such as contractual terms and conditions existing in the SDF are converted to software IF CLAUSES. The output is the Machine contract, that is submitted to a version-controlled repository.
5) the customer and the engraver agree on a risk threshold and on a set of Operative Statements, that are submitted to the Knowledge Database System 222.
6) The Machine Contract is either compiled or interpreted into Machine Code and is submitted to the MCVL 240, which validates the machine contract programme by running the code with all the possible inputs and calls to all the possible functions, classes and libraries. The outputs and related inputs are sent to the Risk Analysis Engine that runs a set of risk algorithms and labels the outputs with their related risk factor. Then the outputs and related inputs are sent to the SDFGL that, with a parser or text analytics algorithms, embeds the outputs to text sentences like “If the image is blurred, black and white and the metal sheet has an irregularity index of at least 20% then the image will be rejected”, that becomes and Operative Statement and with its related risk factor is submitted to the Knowledge Database System.
7) If any of the outputs has a critical risk factor like zero then a major software bug/vulnerability has been detected and a request of change is flagged. The machine contract is changed and resubmitted.
8) The Draft Contract is submitted to a text analytics engine, which outputs Knowledge Database Systems queries that generates Operative Statements with related risk factors. For example, the query would be, what are the Operative Statements and related Risk Factors that covers cases in image resolution, image characteristics, material characteristics and material curvatures in the fields of laser metal engraving?
9) Now there are 3 sets of Operative Statements with risk factors. The ones as output of the MCVL, the ones agreed by the engraver and the machine owner, the ones as output of the queries of the text analytics engine. All of those that have a risk factor higher than the decided threshold are appended to the SDF, the output is a Legal Contract, that is digitally signed by the engraver and the machine owner, hashed and submitted to a DLT that can be accessed by both.

If a disagreement is generated between the customer and the engraver, a Trade Dispute is flagged and written as an Operative Statement. That is an input to the text analytics engine and its outputs, together with any type of type of sensors reading (like IOT) and the output become Knowledge Database System queries, that generates Operative Statements with related risk factor. The customer and the engraver are asked to review and if they agree to append the new Operative Statements to the Legal Contract. If they disagree a panel of experts is asked to review. Depending on the decision a Legal Contract is digitally signed, hashed and submitted to a DLT that can be accessed by all the Principals or a subset of them. The New Operative Statements are also submitted to the SDFGL, the MCGL and the MCVL and a new Machine Contract is generated.

### Example 7: Managing and Controlling the Delivery of Goods with Fleets of Autonomous Drones

Supporting the delivery phase of goods with fleets of autonomous drones is a hard problem in which the delivery is subject to uncertain factors like weather conditions and, moreover, the price of the delivery itself is dependent on the inputs of weather forecast models. The delivery phase is governed by a legal contract that manages and controls to the operations of the drones' fleet with machine code.

A customer contracts with the operator of a fleet of autonomous drones for the delivery of goods. The contract regulates the decision and method of the fleet to deliver the goods subject to uncertain conditions like weather and it can price the delivery subject to the inputs of weather model forecasting. The contract translates in a Machine Contract that, when run on the drones' fleet system, instructs the drones on the trajectories, time of flight and computes a related price.

1) the customer and the drones owner write a Draft Contract, that is submitted as input data to the digital contract platform 200 via the User Interface 210 where it may be digitalised, digitally saved and stored on the master versioning database 260, e.g. a DLT.
2) the Draft Contract is digitally signed and stored on the DLT that can be accessed by any authorised user.
3) the Draft Contract is submitted to the SDFGL 220, where it is used to generate a Source Data File (SDF) by means of a parser, which extracts from the draft contract operative data like sector (delivery/drones/weather dependent), users (type of goods), type of transaction (delivery when and at which price), inputs (weather forecast/goods weight). The parser 230 may further extract the contractual terms and conditions specified in the draft contract.
4) The SDF is submitted to the MCGL 232 that parses the SDF, extracts operative data (delivery/drones/weather dependent/type of goods/goods weight) and converts the operative data to software statements that write calls the appropriate libraries (drones flight management and delivery pricing), the appropriate functions (fly, where and how and price), appropriate variables and objects for. Operative statements such as contractual terms and conditions existing in the SDF are converted to software IF CLAUSES. The output is the Machine contract, that is submitted to a version-controlled repository.
5) the customer and the drones owner agree on a risk threshold and on a set of Operative Statements, that are submitted to the Knowledge Database System 222.
6) The Machine Contract is either compiled or interpreted into Machine Code and is submitted to the MCVL 240, which validates the machine contract programme by running the code with all the possible inputs and calls to all the possible functions, classes and libraries. The outputs and related inputs are sent to the Risk Analysis Engine that runs a set of risk algorithms and labels the outputs with their related risk factor. Then the outputs and related inputs are sent to the SDFGL that, with a parser or text analytics algorithms, embeds the outputs to text sentences like “If a storm is forecasted and the goods are fragile then the price will be at least $$$$ with a risk of 30%”, that becomes and Operative Statement and with its related risk factor is submitted to the Knowledge Database System.
7) If any of the outputs has a critical risk factor like zero then a major software bug/vulnerability has been detected and a request of change is flagged. The machine contract is changed and resubmitted.
8) The Draft Contract is submitted to a text analytics engine, which outputs Knowledge Database Systems queries that generates Operative Statements with related risk factors. For example, the query would be, what are the Operative Statements and related Risk Factors that covers cases in drones' fleets, goods types, weather forecast dependencies in the fields of goods delivery?
9) Now there are 3 sets of Operative Statements with risk factors. The ones as output of the MCVL, the ones agreed by the customer and the drones owner, the ones as output of the queries of the text analytics engine. All of those that have a risk factor higher than the decided threshold are appended to the SDF, the output is a Legal Contract, that is digitally signed by the engraver and the machine owner, hashed and submitted to a DLT that can be accessed by both.

If a disagreement is generated between the customer and the drones owner, a Trade Dispute is flagged and written as an Operative Statement. That is an input to the text analytics engine and its outputs, together with any type of type of sensors reading (like IOT) and the output become Knowledge Database System queries, that generates Operative Statements with related risk factor. The customer and the engraver are asked to review and if they agree to append the new Operative Statements to the Legal Contract. If they disagree a panel of experts is asked to review. Depending on the decision a Legal Contract is digitally signed, hashed and submitted to a DLT that can be accessed by all the Principals or a subset of them. The New Operative Statements are also submitted to the SDFGL, the MCGL and the MCVL and a new Machine Contract is generated.

1. A digital contract computer platform configured to generate, validate, manage, and monitor executable machine contract programmes representing corresponding digital contracts, each configured for controlling and monitoring the operation of one or more contract input data sources, the digital contract computer platform comprising
a User Interface, UI, accessible by at least one user through a computer device; and
a digital contract generation logic configured to generate a digital contract to control and/or monitor the operation of one more user specified contract input data sources, based on input data received from the at least one user through the User Interface, UI, the digital contract generation logic comprising:
a source data file generation logic, SDFGL comprising
a semantic search query generation logic, SSQGL, configured to generate, based on information extracted from the user input data, at least one search query comprising a plurality of search criteria;
a knowledge database system comprising an operative statement database containing a plurality of operative statements each tagged with a set of metadata information, and a semantic search engine configured to execute the at least one search query generated by the SSQGL so as to identify and retrieve from the operative statement database a set of operative statements associated with metadata information matching the search criteria of the at least one search query, wherein the retrieved operative statements are configured to control and/or monitor the operation of the one or more user specified one or more contract input data sources during the execution of the digital contract;
a document generation logic configured to present to the user for selection, through the User Interface, the operative statements retrieved from the operative statement database, and, based on the user selection, to generate a source digital data file;
a parser logic configured to extract operative data from the operative statements in the source digital data file, the parser logic configured to generate, based on the extracted operative data, a machine contract programme, which when executed performs the operations specified in the operative statements contained in the source digital data file;
a machine contract validation logic, MCVL, comprising an execution engine which is configured to execute the machine contract programme for different contract data input combination values to determine the executional performance of the digital contract under different operating scenarios and/or conditions, the MCVL is configured to assign a risk factor to each operative statement, which is compared to a predetermined performance threshold, wherein if the risk factor is within a first threshold range from the performance threshold, then a validation signal is generated, otherwise the MCVL generates an alert signal, indicating a vulnerability in the machine contract programme, wherein upon receiving a validation signal the machine contract programme is transmitted to the at least one user to be signed, and upon signature the machine contract programme is hashed and placed on a versioning database ready to be used for execution by a desired application associated with the corresponding one or more contract input data sources; and
a performance monitoring module communicatively coupled to contract input data sources associated with the machine contract programme, the performance monitoring module being configured to monitor the execution of the digital contract by monitoring the operation of the corresponding contract input data sources and accordingly evaluate, based on input data received from the connected contract input data sources, the performance of the machine contract program.

2. The digital contract computer platform claim 1, wherein the MCVL is configured to validate the performance of the generated machine contract programme by at least applying a set of input value combinations to the contract data inputs and recording the corresponding output values for each operative statements.

3. The digital contract computer platform of claim 2, the MCVL comprising a risk analysis engine configured to assign a risk factor to each of the corresponding operative statements associated with each output value, the risk factor being indicative of the enforceability of each operative statement by the digital contract and/or the functionality of the machine contract programme during execution.

4. The digital contract computer platform of claim 1, wherein the digital contract generation logic comprises a master data file generation logic, MDFGL, configured, upon receiving a validation signal, to generate, based on the content of the source digital data file, a master digital data file representing the underlying legal contract containing the contractual terms and conditions executed and/or monitored by the digital contract, wherein at least the master digital data file is forwarded to the at least one user and/or parties to the digital contract for approval, and wherein upon approval, the master digital data file and the corresponding machine contract programme are stored in a versioned database.

5. The digital contract computer platform of claim 1, wherein the metadata information comprises a risk factor, a classification, an ontology, or expected output values of each operative statement for different input value combinations.

6. (canceled)

7. (canceled)

8. The digital contract computer platform of claim 1, wherein the knowledge database system, comprises a knowledge graph logic configured to update and enrich the operative statements and associated metadata information stored in the operative database with information received and/or retrieved from a plurality of information sources.

9. The digital contract computer platform according to claim 8, wherein the plurality of information sources comprises external connected devices and systems, the output values generated from the machine contract validation logic, information received from the at least one user and/or the administrator of the system, or the contract input sources.

10. The digital contract computer platform of claim 8, wherein the knowledge graph logic comprising a set of trained algorithms configured to update and enrich the operative statements and associated metadata information.

11. The digital contract computer platform of claim 1, wherein the machine contract programme and master digital data file are hashed and stored in the versioning database.

12. The digital contract computer platform of claim 1, wherein the MCVL is configured to validate the machine code program by:
reading the machine contract programme;
generating a set of test conditions for each operative statement;
executing the machine contract programme for each test condition;
storing the output values generated from each test condition;
generating, for each output value, the corresponding set of operative statements by submitting the output values to the parser logic, whereby each output value is processed and associated with a corresponding operative statement; and
assigning, by means of a risk analysis engine, a risk factor to each generated operative statement.

13. The digital contract computer platform of claim 12, wherein the risk analysis engine is configured to assign a risk factor to an operative statement, based on metadata information stored in the graph database.

14. The digital contract computer platform of claim 13, wherein the risk analysis engine comprises a statistical risk calculation engine configured to calculate a risk factor based on historical information associated with an operative statement.

15. The digital contract computer platform of claim 14, wherein the historical information is retrieved from information stored in the knowledge graph logic or retrieved from external information sources.

16. The digital contract computer platform of claim 1, wherein the performance monitoring module is configured to periodically validate the performance of a machine contract programme stored in the version database by resubmitting it for validation to the machine code validation logic, MCVL.

17. The digital contract computer platform of claim 16, wherein the step of resubmitting the machine contract programmes to the machine code validation logic, MCVL, is triggered by an update of the content of the operative statement database.

18. The digital contract computer platform of claim 1, wherein the performance monitoring module is configured, upon detecting an executional performance issue with a machine contract programme and/or receiving a dispute communication from at least one of the parties and/or at least one user, for issuing a dispute notification signal.

19. The digital contract computer platform of claim 18, wherein the performance monitoring module comprises a dispute resolution engine configured, upon the issuance of a dispute notification signal, to activate a dispute resolution event sequence, and notify the parties involved or at least one user of the suspension of the disputed contract.

20. The digital contract computer platform of claim 19, wherein the dispute resolution engine is configured to suggest dispute resolution proposals to at least one user and/or parties for resolving the contract dispute, and wherein upon an acceptance by the parties and/or at least one user of a dispute resolution proposal, the dispute resolution engine is permissioned to generate an updated master digital data file and corresponding machine contract programme for the disputed contract and resume the execution of the updated digital contract.

21. (canceled)

22. (canceled)

23. (canceled)

24. (canceled)

25. (canceled)

26. (canceled)

27. The digital contract computer platform of claim 1, wherein the digital contract generation logic comprises a cryptographical module comprising a set of cryptological protocols for hashing, digitally signing and encrypting data stored in the versioned database.

28. A method for generating, validating, managing, and monitoring executable machine contract programs representing corresponding digital, the method comprising:
accessing, through a User Interface running on the computer device of at least one user, a digital contract generation logic configured to generate a digital contract, based on input data received from the at least one user through the User Interface, UI, wherein the digital contract generation logic is configured to perform the steps of:
generating, based on information extracted from the user input data, at least one search query comprising a plurality of search criteria;
searching in an operative database for operative statements matching the search criteria, wherein the operative statements are configured to control and/or monitor the operation of at least one contract input data source during the execution of the digital contract;
presenting to the user for selection through the UI, the retrieved set of operative statements, and, based on the user selection, to generate a source digital data file;
generating, based on the extracted operative data, a machine contract programme, which when executed performs the operations specified in containing a set of software programme statements representing the extracted operative data, which machine contract programme represents the digital contract executing the operative statements contained in the source digital data file;
validating by means of a machine contract validation logic, MCVL, the executional performance of the generated machine contract programme under different operating scenarios and/or conditions by assigning a risk factor to each operative statement, which is compared to a predetermined performance threshold, wherein if the risk factor is within a first performance threshold range from the threshold, then a validation signal is generated, otherwise the MCVL generates an alert signal, indicating a vulnerability in the machine contract programme, wherein upon receiving a validation signal the machine contract programme is transmitted to the at least one user to be signed, and upon signature the machine contract programme is hashed and placed on a versioning database ready to be used for execution by a desired application; and
monitoring and evaluating the execution and performance of the digital contract based on input data received from the corresponding connected contract input data sources associated with the operative statements of the machine contract programme.
